(19) United States
(12) Patent Application Publication
(10) Pub. No.: US 2019/0138645 A1
(43) Pub. Date: May 9, 2019

(54) AUTOMATED DOCUMENT ASSISTANT WITH TOP SKILLS

(71) Applicant: Microsoft Technology Licensing, LLC, Redmond, WA (US)

(72) Inventors: Hang Zhang, San Jose, CA (US); Kylan Matthew Nieh, Fremont, CA (US)

(21) Appl. No.: 15/806,072

(22) Filed: Nov. 7, 2017

(51) Int. Cl. G06F 17/30; G06F 17/24

(52) U.S. Cl. CPC G06F 17/30643; G06F 17/248; G06Q 50/01; G06F 17/30011; G06F 17/30528; G06F 17/3053

(57) ABSTRACT

In some embodiments, the disclosed subject matter involves online, or Web-based, automated assistance with documents using examples, and, more specifically, to providing an online user with automatic and quality ranked examples of content that are related to the context of a document that the user is drafting. The quality criteria may be used to train a model to assist in ranking candidate examples Δn embodiment uses a resume assistant add-in to a document editor to provide relevant work experience examples to the user to be rendered on a display in proximity to a resume being edited. The add-in communicates with a backend server via an API, where the backend serve pre-processes available content and stores candidate examples having user selectable criteria in key-value form. Experience examples may be generated to focus on a specific user selectable criteria for inclusion in the displayed examples. Other embodiments are described and claimed.

### TECHNICAL FIELD

An embodiment of the present subject matter relates generally to online automated assistance with documents using examples, and, more specifically, to providing an online user with automatic examples of content that are related to the context of a document that the user is drafting, and allow dynamic rendering of examples with focused criteria information.

### BACKGROUND

Various mechanisms exist for assisting users with the generation of documents. For various applications, forms, templates and complete example documents may be available for a user to copy, paste or format a document users have been manually copying the content or format of previously generated document using electronic copy and paste, or retyping content. Users new to the generation of a document type, may obtain copies of similar documents through web searches, requesting a copy from friends or colleagues, etc. However, there is no guarantee that the template used, or the content copied, or relied upon is fully relevant, accurate or of high quality. Further, obtaining quality example content may be time consuming.

### BRIEF DESCRIPTION OF THE DRAWINGS

In the drawings, which are not necessarily drawn to scale, like numerals may describe similar components in different views like numerals having different letter suffixes may represent different instances of similar components. Some embodiments are illustrated by way of example, and not limitation, in the figures of the accompanying drawings in which:

FIG. 1 illustrates an online resume assistant application which uses automated work experience examples, according to an embodiment.

FIG. 2 illustrates an online resume assistant application with role and industry selected, according to an embodiment:

FIG. 3 illustrates a Web-based search for skills;

FIG. 4 illustrates an online resume assistant application with role, industry and skill, according to an embodiment;

FIG. 5 illustrates an online resume assistant application showing top skills selection for a role, according to an embodiment;

FIG. 6 illustrates an online resume assistant application showing work experience examples associated with a role, industry and a top skill, according to an embodiment;

FIG. 7 illustrates an online resume assistant application showing various recommendations or suggestions, according to an embodiment

FIG. 8 illustrates an online resume assistant application showing suggested jobs, according to an embodiment;

FIG. 9 illustrates an online resume assistant application showing suggested jobs, and additional suggestions, according to an embodiment;

FIG. 10 illustrates an online resume assistant application showing work experience examples using smart snippets, according to an embodiment:

FIG. 11 is a block diagram illustrating components of an online automated document drafting assistant, according to an embodiment;

FIG. 12 illustrates a method for selecting content examples, according to an embodiment:

FIG. 13 illustrates a method of the backend for generating N positions for use as examples, according to an embodiment:

FIG. 14 illustrates a method for candidate ranking and generation in the backend to filter out low quality examples, according to an embodiment;

FIG. 15 is a flow diagram for an exemplary method for top skill identification, according to an embodiment:

FIG. 16 is a flow diagram, of an exemplary method for creating smart snippets for an example according to an embodiment, and

FIG. 17 is a block diagram illustrating an example of a machine upon which one or more embodiments may be implemented.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system method, means and computer readable medium relating to online automation for providing relevant content examples of high quality to a user creating an online document or form. While embodiments for providing content examples may be applied to varying document types and scenarios, for illustrative purposes the discussion herein describes an example embodiment of a resume assistant with work experience examples. It will be understood that the systems and methods described herein may be applied to obtaining examples for job postings instead of resumes, or providing examples for writing employee annual reviews, or any variety of applications where a database including examples is available.

It will be understood that millions of people generate or update their resumes on a frequent basis for purposes of finding, and maintaining employment, or for use as current biographical data, for instance for use when speaking publicly or for use on a book jacket, etc. When job seeking, a person may need help drafting their resume, for instance, for properly describing work experience or describing experience related to new or popular skills. Using random resumes or templates found in a public search on a public network such as the Internet may yield irrelevant or inferior content A person may spend thousands of dollars employing a professional resume writer or public relations (PR) consultant to help improve their resume. However, in today's job market, being the first to apply may give a person the advantage over people who apply days or weeks after a job has been posted. Thus, time searching for examples, or waiting for feedback and results from a professional writer may cause significant delay in applying for a job. Embodiments herein included an online automated system for providing real time assistance for resume writing and provide quality, relevant content examples that the user can modify and incorporate into their resume for faster response to job postings with a quality resume.

Embodiments may be applicable to work experience content related to a job posting. A recruiter may be told by the hiring manager that she wants candidates with certain skills for a project that are not well known to the recruiter. The title of the job is known, and the recruiter may use an automated online system for providing job requirements content so that the job posting may be quickly drafted and publicized. Other applications for using content examples where time is of the essence may leverage the methods as discussed herein.

Reference in the specification to “one embodiment” or “an embodiment” means that a particular feature, structure or characteristic described m connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

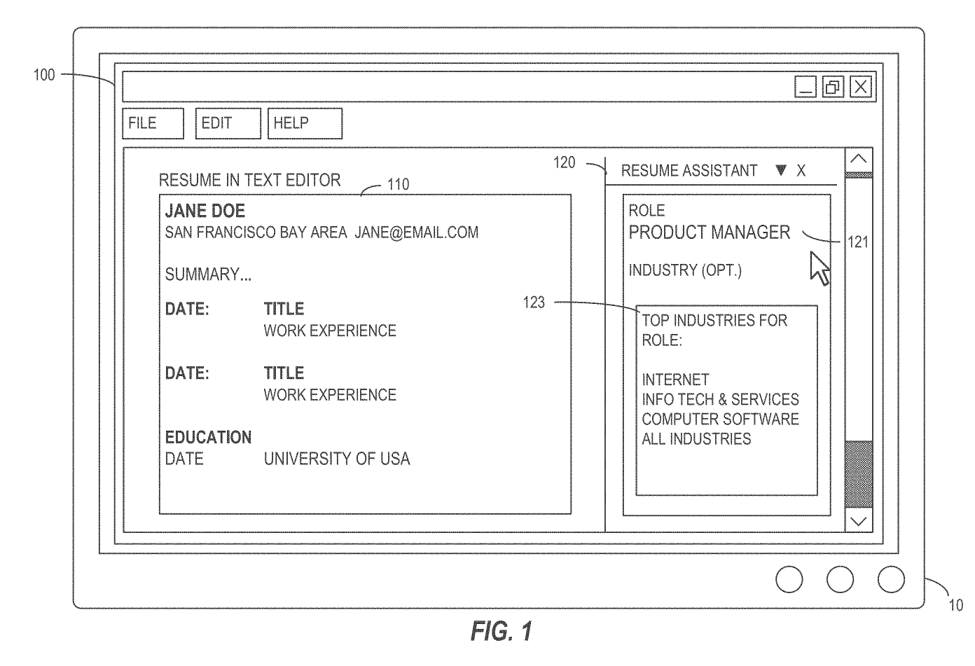

FIG. 1 illustrates an online resume assistant application which uses automated work experience examples, according to an embodiment. In an embodiment, application window 100 may be opened with a text editor, such as Microsoft® Word. and rendered on a display device 10. A resume or other document is opened in the text editor and displayed at 110. A resume assistant 120 may be launched and displayed to the right, or otherwise adjacent to the text editor 110. In an embodiment, the resume assistant 120 may be launched as a plug-m or add-in to the text editor 110, and be displayed adjacent to the text document 110, to the right, left, above or below the text document, so that both windows, frames or display portions may be viewed on a display monitor at the same time. In another embodiment, the resume assistant display may be launched as a separate window or process, a different frame, or a subordinate window, pop-up, or process to the text editor 110. Communication between text editor 110 and resume assistant 120 may be effected by interprocess communication, shared memory, message passing protocols, shared data structures, etc. Plug-in protocols may simplify communication between the two processes.

In an embodiment, once the user launches the resume assistant 120, a title or role may be entered in a text entry area 121. In the following discussion the terms “title” and “role” may be used interchangeably, and the terms “position” and “work experience” may be used interchangeably. For instance, a user, Jane Doe, may wish to update her work experience for a new job, skill or task to ensure that her resume is up to date, and reads well to recruiters or other hiring individuals. In the example, the role of Product Manager has been selected at 121. This role, or title, may be applicable to more than one industry. For instance, in this example, Product Manager may be applicable to multiple industries. In an embodiment, the user may select one of the Top Industries 123, such as Internet. Info Tech & Services, Computer Software, or All Industries, in a user selection portion of the display. In an embodiment, the user may click on the desired industry from a list, a drop down list, enter the industry by typing, or similar entry methods A list of top industries may be retrieved from an online database, stored in memory as part of the resume assistant or be dependent on the role selected A list of valid role-industry pairs may be available in the resume assistant 120, or retrieved in real time from a remote database. In an embodiment, an industry may be shown if a valid role-industry pair exists. In another embodiment, an industry may not appear in the selection list unless there are candidate work experience examples related to the industry and selected role, to be discussed more fully, below.

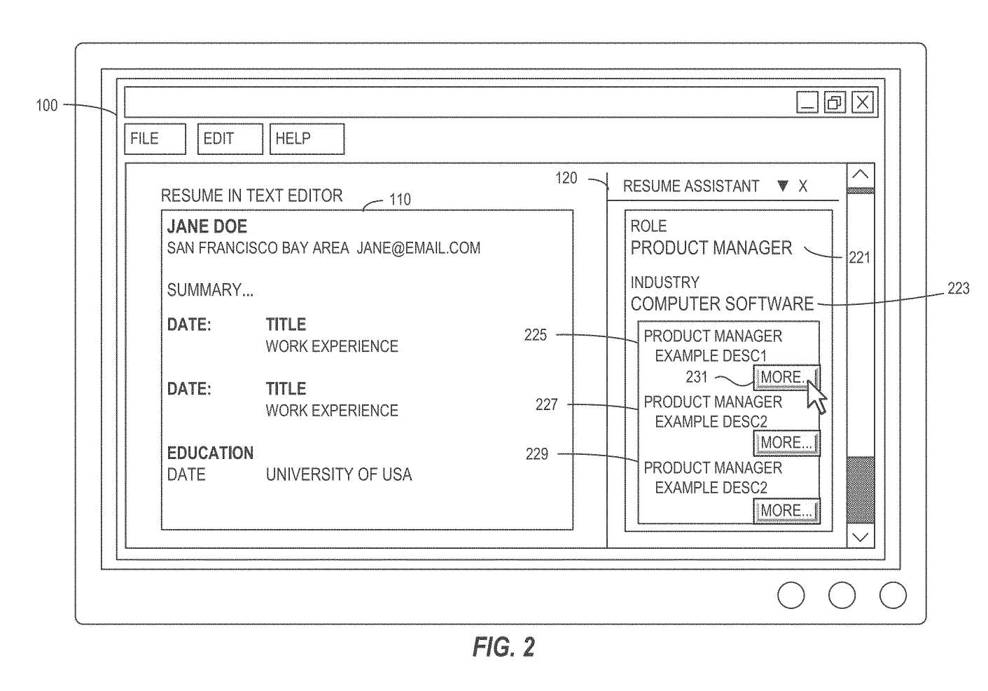

FIG. 2 illustrates an online resume assistant application with role 221 and industry 223 selected, according to an embodiment. In this example, the user has selected the role of product manager 221 in the industry of computer software 223. In an embodiment, once the role 221 and, optionally, industry 223 are selected, work experience examples 225, 227, 229 are automatically displayed in the resume assistant display area 120. In an example, only a portion of the work experience example may be visible to the user. In an example, the first sentence or two of the example may be displayed. In another example, a portion (e.g., snapshot, or snippet) of the example may be selected for display based on a selected or perceived context. The user may select one of the examples 225, 227, 229 to view additional information about the selected example. In an embodiment, a button 231 may appear adjacent to the example that when selected will bring up more information, or the full example description. An variety of user input methods may be used to indicate that more information is desired, for instance, selection of the item, an index or checkbox associated with the item, a button, etc. For instance, the example may be selected by scrolling the cursor and clicking on the example or selecting the index of the example in another window portion (not shown), or by utilizing a variety of interactive user interface protocols including touch or voice.

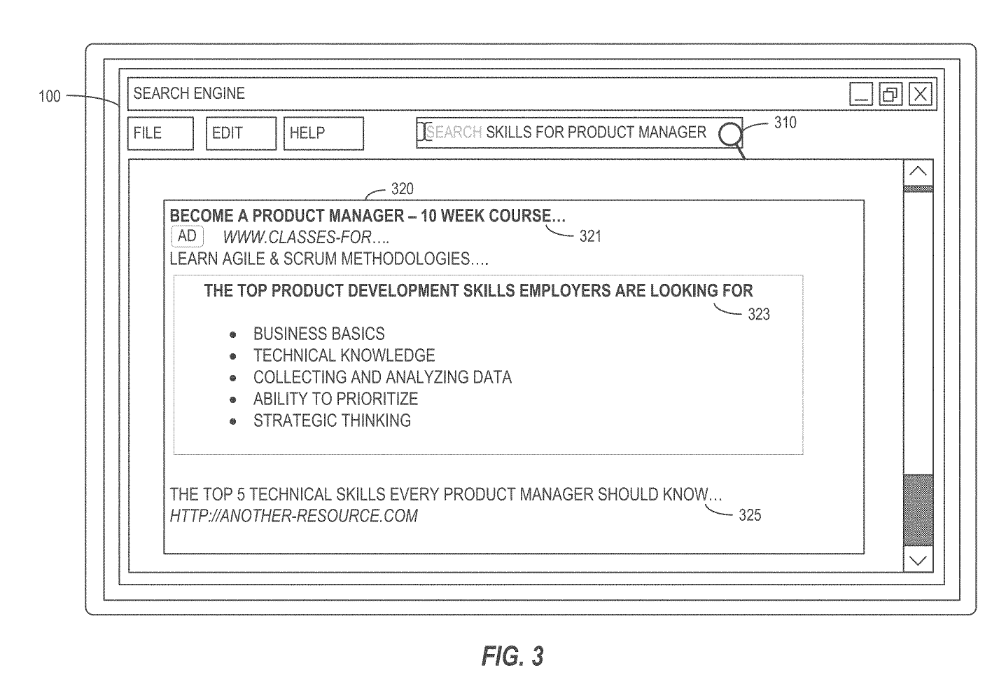

FIG. 3 illustrates a Web-based search for skills as might be utilized for manual assistance in document drafting. Without availability of an automated resume assistant, a user who desires to update her resume might have retrieved information from a search on the public Internet. If, for instance, a user wanted to add text related to product manager skills, a text search of “Skills For Product Manager” might be entered in the search box 310. However, the results shown in at 320 may or may not be useful. Advertisements for classes 321 may appear which will not immediately help the user update her resume. A list of top skills 323 or an article on technical skills for product managers 325 may be displayed, with unknown value to resume writing. The search results are only as good as the search criteria entered, and the search engine used. There are no guarantees that the results, when viewed, will contain valuable information with respect to the user's resume. Further, a search engine typically runs independently of the document editor and cannot pass information back and forth easily or automatically.

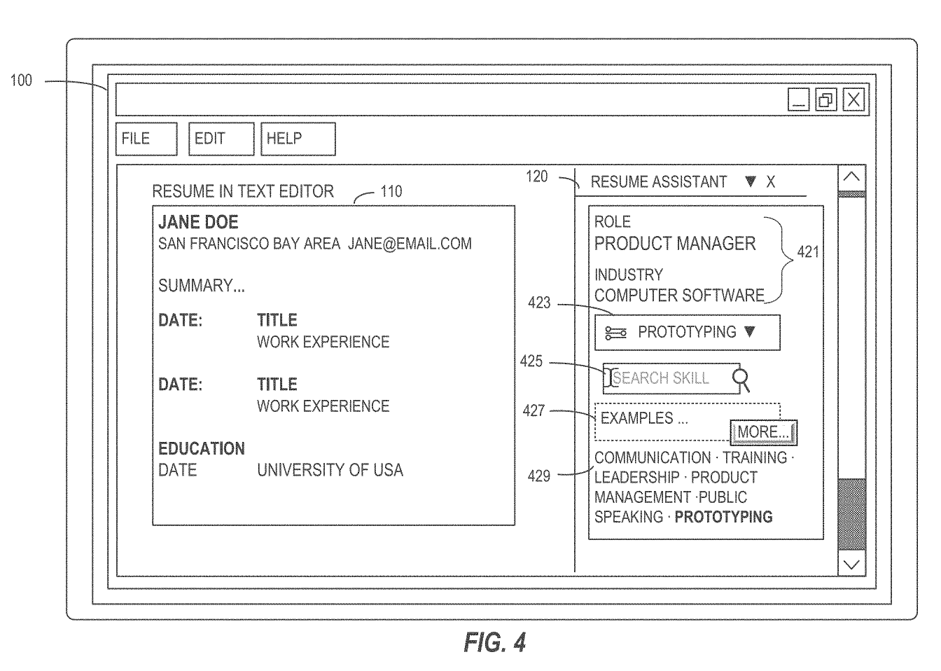

FIG. 4 illustrates an online resume assistant application with role, industry and skill, according to an embodiment. In an embodiment, more relevant work experience examples may be provided to the user by including a skill criteria. In an example, the user resume text 110 is displayed on the left of a display area. The resume assistant plug-in 120 is displayed on the right of the display area, adjacent to the resume 110. A role and industry have been selected and displayed 421 in the resume assistant 120. In an embodiment, a list of skills appropriate for the role/industry pair may be provided in a drop down selection list 423. In an embodiment, a user may search for a specific skill not shown in a text input box 425. Once a skill has been selected and entered by the user, a relevant list of work experience examples may be displayed 427. In an example, work experience examples previously displayed may be filtered so that only examples including the selected skill 423 are shown to the user at 427. Various methods of selection may be available such as selection by scrolling the cursor and clicking on the listed skill, selecting the index of the skill in another window portion (not shown), or by utilizing a variety of interactive user interface protocols including touch or voice, etc. In an embodiment, drop down list 423 may include only those skills having candidate examples associated with both the selected role and industry. In an embodiment, skills that appear in role-industry pairs stored offline may be shown as a list, adjacent to the examples 429. In an embodiment, only those skills that appear in work experience examples presented to the user may appear at 429. In an embodiment, a user may select a skill from a drop down 423, text entry box 425, or from a listed skill 429. Various embodiments may display one or more selection methods for skill entry. In an embodiment, a list or drop down selection may be limited to those skills that are deemed to be Top Skills, to be discussed more fully below.

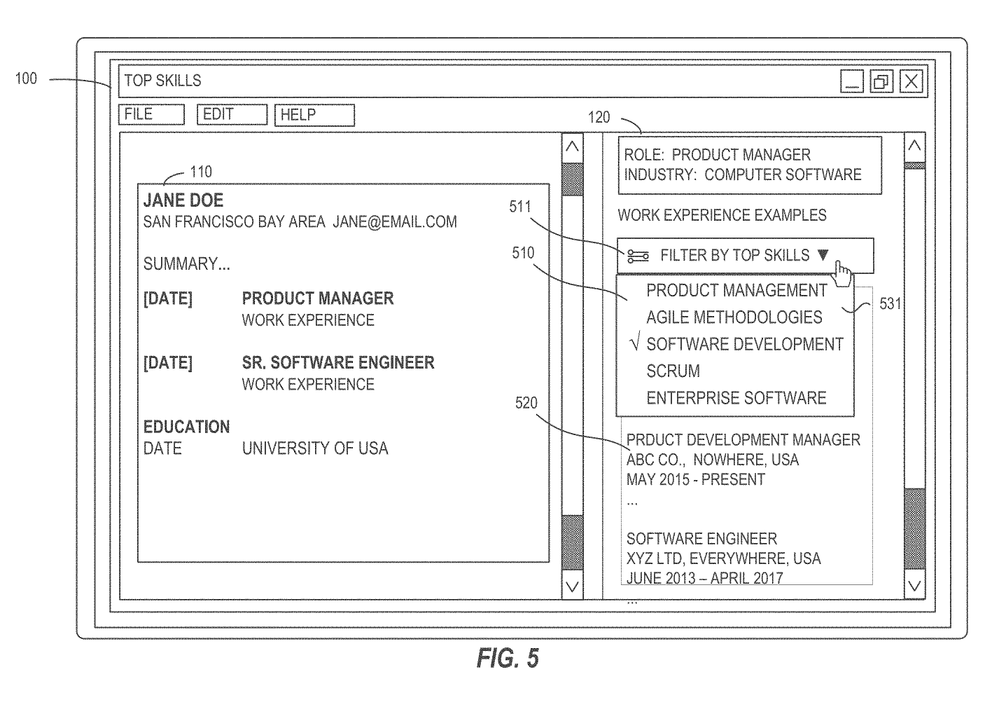

FIG. 5 illustrates an online resume assistant application showing top skills for a role, according to an embodiment. In an embodiment, a resume 110 in a document editor 100 may be displayed adjacent to a resume assistant 120. A variety of relevant information and interactive criteria selection may be available to the user. In an example, top skills 510 may be displayed for a selected role. A drop down box 511 may be available for the user to select a to skill. In an embodiment, only identified Top Skills are available in the drop down selection box 511. In this illustrated example, a user selects a top skill of “Software Development” as the skill by which to filter the work experience examples 520.

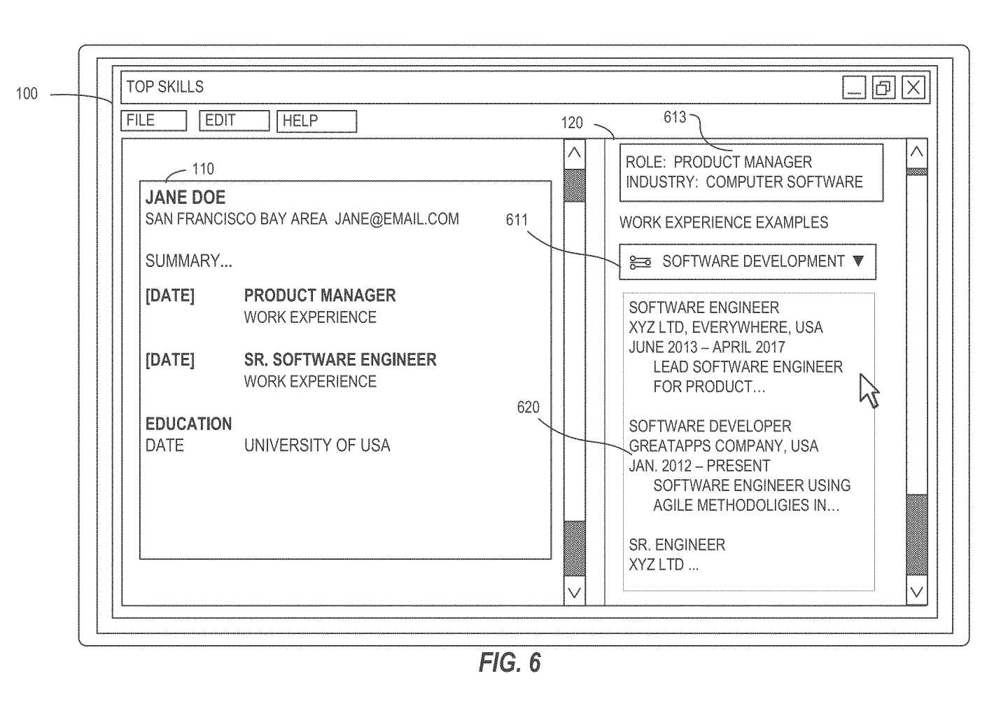

FIG. 6 illustrates an online resume assistant application showing work experience examples associated with a role, industry and a top skill, according to an embodiment. In an example, a user has selected a role or role-industry pair 613. Work experience examples are then automatically displayed 620. In an example, when a top skill is selected 611, the work experience examples 620 are automatically filtered to omit any work experience that does not contain a description including a top skill. In an embodiment, a quantity M of work experience examples is provided to the resume assistant 120. If filtering out examples that do not include the selected top skill 611 result in significantly fewer than M results, a new query may be sent to retrieve M new work experience examples that include only role-skill or role-industry-skill criteria. Various techniques may be used to display the skill relevant examples in one or more embodiments. For instance, previously displayed work experience examples may be re-ordered to match the rank order of the top skills where examples not exhibiting the selected top skill appear lower on the list. The examples may be re-ordered based on a first ranking of the selected top skill, and then a secondary ranking of other top skills appearing in the work experience examples. It will be understood that a variety or ordering, re-ordering and display rendering may be used. In an embodiment, the rank ordering may be pre-defined in the plug-in architecture, or be user selectable (e.g., allowing a user to select more than one top skill).

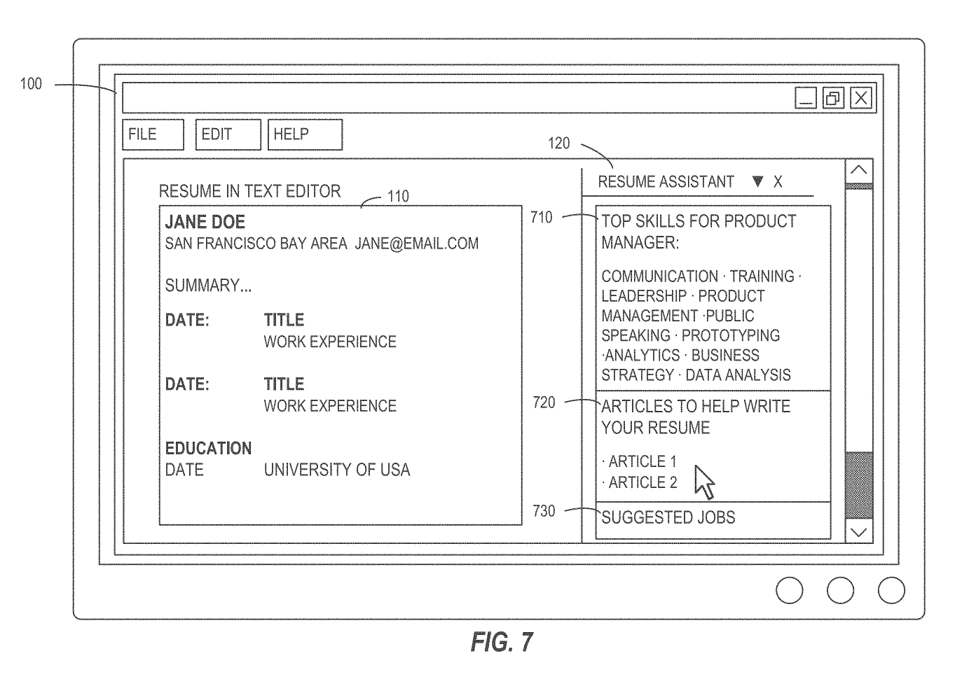

FIG. 7 illustrates an online resume assistant application showing various recommendations or suggestions, according to an embodiment. In an embodiment, a user may be presented with more than one possible recommendation for selection. For instance, a user may have selected a product manager as role and be presented with a list of top skills for selection 710, a list of selectable articles or other background information 720 that may be suggested to assist the user in creating or editing their document 110. In another example, suggested jobs 730 may be offered that are relevant to the selected role and/or selected skill.

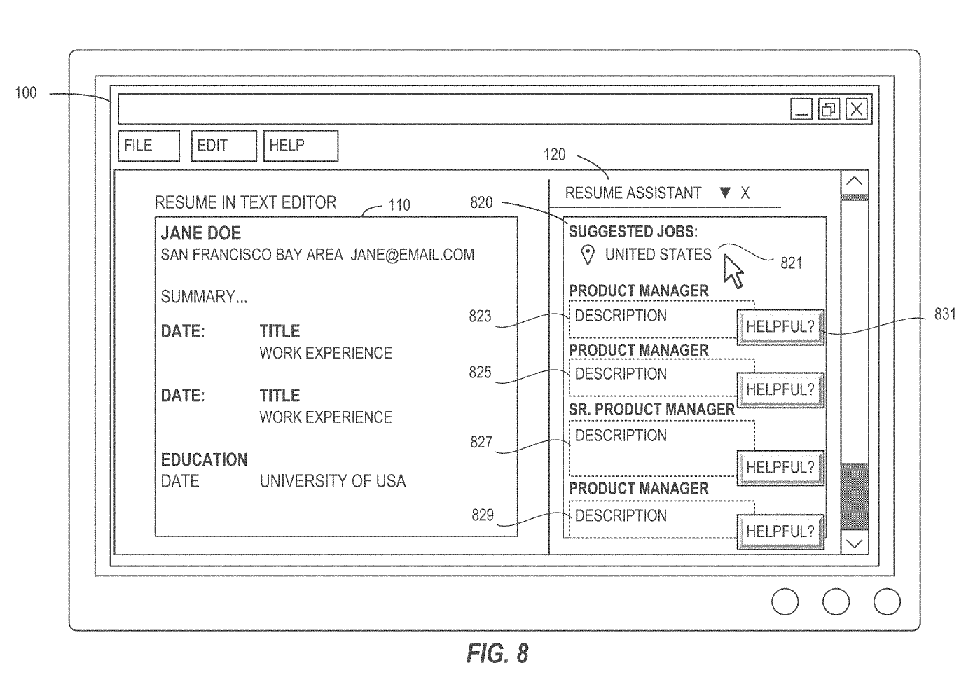

FIG. 8 illustrates an online resume assistant application showing suggested jobs, according to an embodiment. In an embodiment the resume assistant 120 may provide a list of suggested jobs 820, where the jobs are selected based on the selected role. A geographic location 821 may be optionally selected to filter jobs to areas of interest. A list of suggested jobs 823, 825, 827, 829 may be provided with short description or snippet of the available text. The text shown in the job description may be filtered or selected based on role, industry or skill (not shown). A variety of natural language or context models may be used to prepare a subset of the text known as a “smart snippet.” The smart snippet may contain required experience, or skills required for the job, or list corporate information, etc. Smart snippet filters may be pre-determined or available criteria may be ranked and selected by the user. The smart snippet may be based on a selected top skill, or other focused criteria, as described more fully, below. The user may provide feedback as to whether the suggested job is helpful by selecting a button 831. Other methods of input may be provided, such as a hover and select, right click, or other interactive user interface protocols including touch and voice, etc. A number of subordinate dialog boxes, windows or input areas may be provided to the user to provide feedback, such as rating the relevance of the job, quality of the snippet provided, etc. The user may view more information about the job by clicking on the job title, or other interactive user interface method, as described above and below. It will be understood that a feedback input entry area 831 may be available for the example or other section so that the user can identify whether or not the provided content is relevant to the selected criteria. Feedback may be reviewed manually or automatically fed into a machine learning model to improve quality of the provided examples or other content. In various embodiments, the model may be supervised or unsupervised.

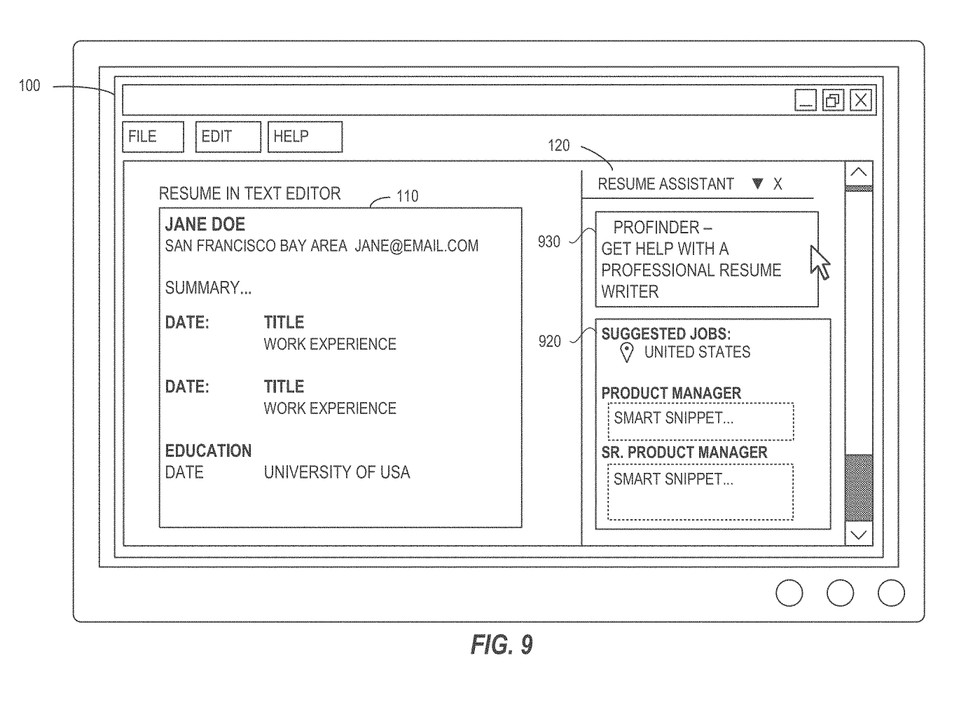

FIG. 9 illustrates an online resume assistant application showing suggested jobs, and additional suggestions, according to an embodiment. In an embodiment, a link to additional suggestions or recommendations may be made to help the user in drafting a quality resume, such as an offer for professional help 930. Suggested jobs 920 may be displayed adjacent or in proximity of the additional recommendation 930. Other links or recommendations may be provided (not shown). It will be understood that any variety of additional recommendation may be provided at 930, in one more windows, panes, pop-up dialog box, or other display area portion, depending on the context of the document type in the text editor 110. In an embodiment, a job posting in suggested jobs 920 may include a smart snippet of the job description where top job skills related to the job posting are highlighted. The smart snippet, to be discussed more fully below, may provide more focused information on the job rather than the first few lines of the job posting.

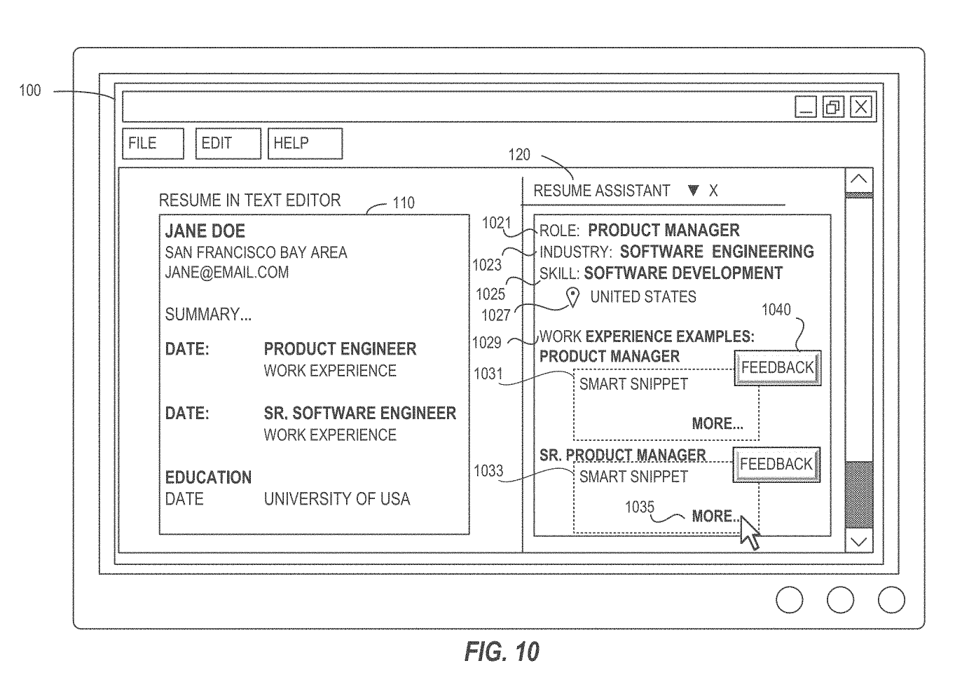

FIG. 10 illustrates an online resume assistant application showing work experience examples using smart snippets, according to an embodiment. In an embodiment, when a user selects a top skill 1025 as a criteria qualifier for a role 1021 or role-industry 1021/1023 combination, work experience examples 1029 may be displayed using smart snippets 1031, 1033. In an embodiment, a geographical location 1027 may optionally be used to further filter work experience examples to a specific geographical area. In an embodiment, work experience examples are provided to the resume assistant for the selected criteria. e.g., role, role-industry, role-industry-geo, etc. When a top skill 1025 is selected, the work experience examples may be filtered to remove examples that do not include the text for the selected skill. The remaining examples may be displayed 1031, 1033 with smart snippets. In an embodiment, a smart snippet may include a portion of the example that includes the skill text. In an example, the smart snippet includes the sentence that includes the skill. In another example, the smart snippet includes one or more lines before and after the reference of the skill. A text or string search of the example may be used to find the occurrences of the skill in the text of the example. The amount of text displayed in the smart snippet may depend on the display resolution of the display device, how much text surrounds the skill text, grammatical or semantic context of the skill text, or other factors that may provide a concise and useful display listing of an example. In an embodiment, a user may provide feedback on the visual or contextual usefulness of the example, for instance by selecting a feedback mechanism 1040. Additional information in an example may be viewed by selecting the item, selecting a button or link for more information 1035, or other user interaction methods including touch or voice input.

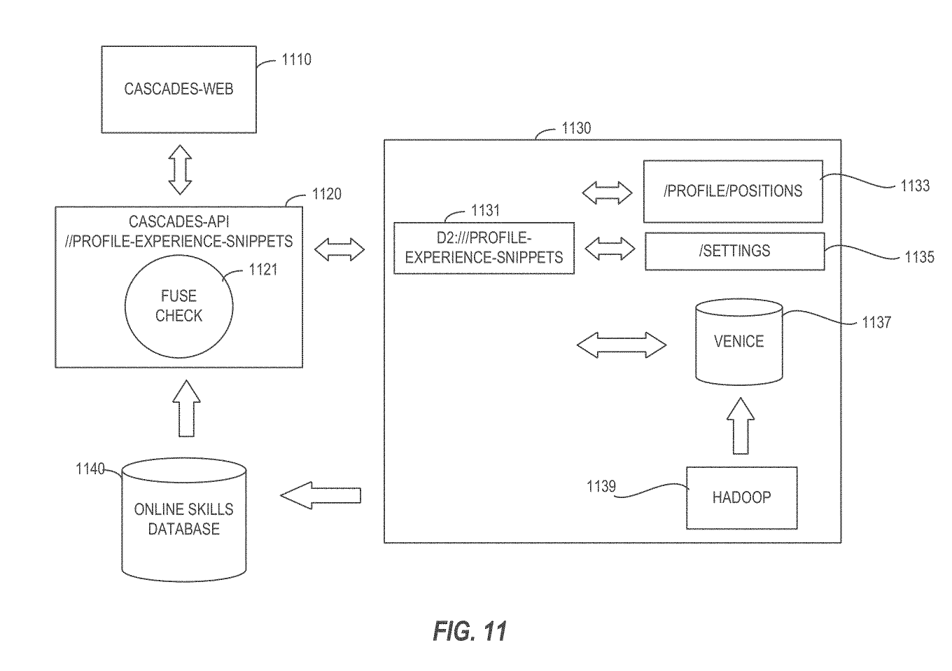

FIG. 11 is a block diagram illustrating components of an online automated document drafting assistant, according to an embodiment. In an embodiment, examples for the preferred content reside m one or more databases. For instance, in the resume assistant and work experience example, job position (e.g., work experience information), job posting information (e.g. recruiter job offerings), corporate information, member profile information, connections and other social media information related to a member profile, may be stored in the member database(s) of a job or career related online application and social network, such as available by LinkedIn®. Work experience information for a given role; role/industry pair; or role/industry/skill triplet may be derived from the member, career and job posting database(s) and leveraged into examples provided to a user editing her resume, or other career related document.

In an embodiment, a user accesses an online (e.g., electronic) document editor with links or plug-in for the automated document drafting assistant. An example of a resume assistant is described herein to illustrate embodiments.

In an embodiment, an offline Hadoop script 1139 may be used to access the one or more member/job databases (not shown) to process the data and provide filtered sets of data to a Venice database 1137. In an example, raw position (e.g., job position, role or title) information with optional skill, geographic and industry filters associated with member profiles in the member database(s) may be accessed and then reduced to smaller, related sets of data that may be used by the resume assistant. For instance, work experience examples may be retrieved and filtered by role (e.g., job title). Work experience examples may also be provided that are filtered by both role and industry. In an embodiment, work experience examples may also be provided that are filtered by role, industry, and skills, or other combinations of criteria. The Hadoop data retrieval 1139 mines and pre-processes the collected data into filtered and reduced data sets for storage in the Venice database 1137. The pre-processing may be performed on a backend processor or server 1130. It will be understood that the pre-processing and filtering of data will vary based on the application at hand (e.g., available data and desired content examples) it will be understood that pre-processing of the content data is important to reduce lag time for the user when requesting examples. In the example of work experience examples, there may be millions of member profiles to be reviewed for quality and relevancy. If each set of work experience examples were to be generated on demand by the user, the lag time might be unacceptable, or fail to meet service level agreement (SLA) requirements. In an embodiment, a Hadoop script agent to pre-process the work experience data may be run daily, to provide timely updated information.

In an embodiment, the Venice storage 1137 is an asynchronous data serving platform which builds upon the lessons learned from operating Voldemort storage at scale. The Voldemort Project is for a distributed key-value storage system. Venice storage 1137 specializes in serving the derived data bulk loaded from offline systems (such as Hadoop 1139) as well as the derived data streamed from nearline systems. Because the derived data use cases do not require strong consistency, read-your-writes semantics, transactions nor secondary indexing. Venice 1137 may be highly optimized for the content use cases for document examples, and deliver a simpler, more efficient, architecture than consistent synchronous systems like Espresso and Oracle® relational databases. Since the data is stored as key-value rather than relational, a set of data to be used for role examples may be stored under the “role” key. If the user desires to view examples for a role-industry pair, a different set of examples will be provided. Similarly, if the user desires examples for role-industry-skill triplets, another set of examples may be stored and provided to the user. Thus, once mined and stored in Venice 1137, a user's request for examples may be serviced very quickly. However, there may be an upper bound on the number of examples stored for each key-value combination to reduce memory costs.

In an example, several resources may be used for the mining and example generation. For instance, in the present example, jobs, skills, company, industry and profile positions (e.g., work experience) may be used. Profile positions may be stored offline in the Venice database 1137 in the present example. Hadoop scripts 1139 may perform the following queries to a member profile database;

get positions by title;

get positions by title and industry;

get positions by title and skill; and

get positions by title, industry and skill.

Once the information is retrieved, the Hadoop script 1139 may store the key-value data of the cases together, rather than separately for ease of application program interface (API) protocol retrieval.

In an embodiment, a document editor plug-in or add-in (e g. Cascade-web) 1110 is a user interface (UI) web service that hosts the static JavaScript and cascade style sheets (CSS) assets. The Web service 1110 may perform service side render or big pipe mode for API data streaming. The cascading style sheet (CSS) assets enable an asset pipeline to provide a framework to concatenate and minify or compress JavaScript and CSS assets. CSS also adds the ability to write these assets in other languages and pre-processors. Using CSS allows assets in an application to be automatically combined with assets from other gems.

The Cascades-web interface 1110 may scan or analyze the document to determine that the document is of the appropriate type for the drafting assistant. Once selected for launch, the drafting assistant pane may be opened in a location adjacent or in proximity to the document, on the display. A title (e.g., job position) may be automatically selected based on natural language understanding and contextual information from the document. In an embodiment, a list of relevant titles may be displayed from which the user may select a desired title. In an embodiment, the user may enter a desired title that may or may not appear within the current document, for instance, in preparation of adding a new position to the resume.

In an embodiment, the Representational State Transfer (REST) API architecture may be used. In recent years, Web APIs following the REST architectural style, also known as RESTful APIs, have been becoming more popular because of their simplicity. REST is a set of principles including stateless communication and a uniform interface. Restful APIs revolve around resources, are addressable via URIs, and provide access to resources to a broad range of frontend consumers via simple HTTP verbs such as GET, PUT. POST, etc. Rest.li is a Java framework that enables easy creation of client-server communication using a REST style of communication. For illustrative purposes, embodiments described herein may use the REST architecture. It will be understood that the methods, algorithms and systems as described may be generalized and applied to other APIs with slight adaptation.

The document editor add-in Cascades-web 1110 may utilize a manifest XML file that points to a Web URL. An embodiment provides an XML file that instructs the document editor to load the Web page at a specified location. The Cascades plug-in 1110 may communicate with an application program interface (API) (e.g., Cascades-API) 1120. The API 1120 may be a REST compliant API. A rest.li resource 1131 in the jobs backend 1130 may read the Venice database 1137 information and perform checks regarding online settings 1135 and profile visibility checks 1133 before exposing the example data anonymously as a work experience snippet.

In an embodiment, work experience examples retrieved from the Venice database 1137 are checked against the profile positions 1133 and settings information 1135 to ensure that the member has made their profile public and allows third parties to use profile information. This information will have been checked at the time the example was saved in Venice 1137, but since the members may change their settings anytime, another check is performed to ensure unauthorized private data is not released. The work experience example is anonymized before being passed to the Cascades-API 1130 so that the member cannot be identified. For instance, member name, company and/or geographical data may be removed from the example before being passed to the user. In some embodiments, a member is required to opt-in before profile information can be used. In other embodiments, a member is required to opt-out before profile information will be omitted.

The Cascades-API 1120 may be used to serve frontend data for the document drafting assistant web application. For a job positions information API, a backend rest.li endpoint may be called to get the data. Once the data is retrieved a FUSE check 1121 may be performed in the Cascades-API 1120. A Filesystem in Userspace (FUSE) is a loadable kernel module for Unix-like computer operating systems that lets non-privileged users create their own file systems without editing kernel code. This is achieved by running file system code in user space while the FUSE module provides only a “bridge” to the actual kernel interfaces. The FUSE check may prevent abuse on the API server and it is based on IP address. For example, if an IP address keeps sending requests to the API server at high frequency, it may affect servicing other requests. Thus, this kind of activity may be considered abuse and the IP address causing the activity may be blocked.

A user may choose to select a top skill for filtering of the work experience examples, as discussed above. In an embodiment, a list of top skills for a role may be stored in an online skills database 1140. The skills data in database 1140 may be synchronized, or consistent with skills information stored in the Venice database 1137. The skills database 1140 may include a list of top skills for a role and rules or information on synonymous terms for a role. Industry information may be ignored m correlation of skills to a role, but may also be defined as criteria or stored as part of the role. For instance, a role may be indexed individually as “product manager,” or indexed as two unique roles for two industries: “product-manager-software” and “product-manager-warehouse-management.” (e.g., for software industry, and warehouse management industry). A method for top skill identification is discussed more fully below. Once the top skills for the selected role are identified, the work experience examples in the Venice database 1137 may be further filtered to include only examples with the selected top skill, and or for textual and contextual information in preparation of the smart snippets, in block 1131, as discussed above.

In an embodiment, smart snippets selection and generation may be performed in the backend processor 1130. Work experience example candidates (that include a given skill) are pre-selected, and their indices are stored (e.g., profile id and position id) into offline storage. When the demand (or query) is received via API that requests the smart snippets for display, a backend process, such as 1131, verifies that the member of that work experience example has not changed his/her visibility setting to be invisible 1135, and that the member has not changed the work experience entry in the profile. 1133 The skill snippets are then extracted from the whole work experience example stored in Venice 1137, using the stored indices as pointers to the work experience example text. One reason to avoid storing the snippets in offline storage, in advance, is that saving snippets requires much more space than just saving the index (IDs). Thus, by storing only indices, the Venice storage 1137 is easy to keep scalable. The skill may be calculated in the offline stage to select work experience example candidates that include this skill. The skill correlation may be calculated again in the backend online process, responsive to the API call, to extract the skill snippet for the frontend to display.

In an embodiment, work experience examples associated with top skills may be pre-processed, using the data of top skills stored offline in a database accessible to the Hadoop scripts 1139. Each work experience example associated with a role may be pre-processed for the list of top skills, and processed as quality candidates for work experience examples. As the top skills list changes for a role, the key-value information for smart snippets will change, also. The Hadoop scripts 1139 may use a string match approach to select smart snippets from the work experience examples when retrieved using the index information. When a resume assistant user uses the application, (e.g. Cascades-Web) 1110, requests are sent through the API (e.g., Cascades-API) 1120. A top skill interface may be obtained by calling the API to online storage 1140 of top skills.

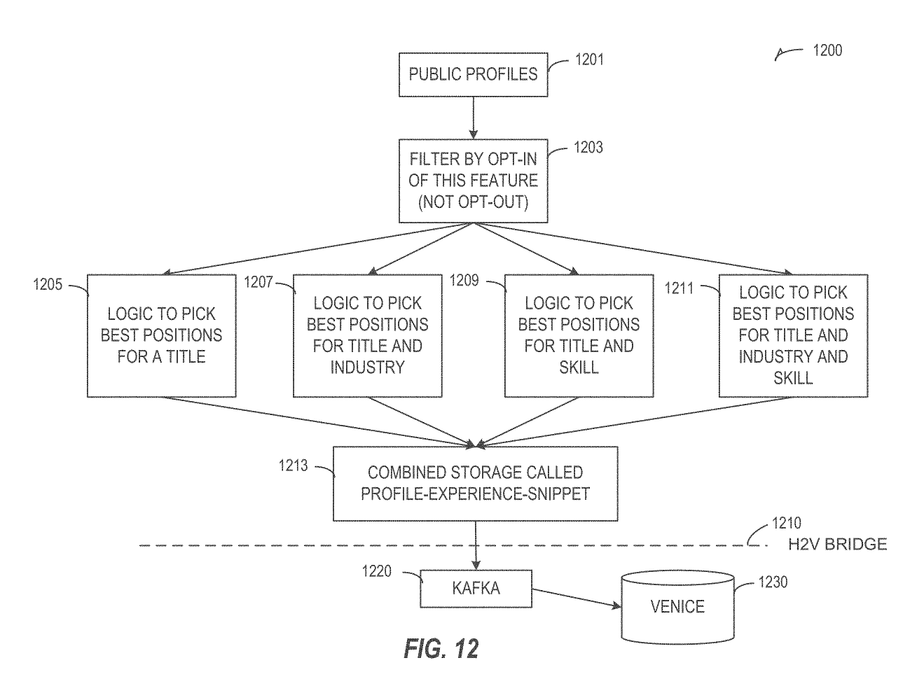

FIG. 12 illustrates a method 1200 for selecting content examples, according to an embodiment. In an embodiment, an agent, process or script may execute in the backend (1230) to generate the key-value entries to be used as content examples. Again, using the application of a resume assistant and job/experience profiles of members, the public profiles of members 1201 are accessed by the agent or script. A determination is made as to whether the member has opted in (or out) to allow their profile information to be used in block 1203. The opt-in/opt-out may be a part of the member's service agreement with the job/experience online Web application, or be provided as a separate agreement to the member. If the user has opted-out, then the profile is ignored and the next profile is accessed.

In the example discussed herein, key-value sets of examples may be generated for title 1205, title-industry 207, title-skill 1209, and title-industry-skill. It will be understood that additional criteria may be added for other sets, such as geographical location, company size, etc. Each additional key-value set of examples will increase the upper bound for storage in the Venice database 1230, and will be bounded by the size of the storage. It will be understood that for other applications, for instance, for a job posting drafting example, other key-value combinations will be used, based on the data available and required criteria. For instance, a job posting example may include title, industry, experience level, education level, or other criteria.

Each member profile position description may be evaluated to rank it as a candidate for example before being stored as a key-value example. For instance, profiles may be filtered out at each logic 1205, 1207, 1209, 1211, based on a variety of criteria to provide quality examples, including:

likelihood of a being spam;

too short in length:

not in English (or other preferred language); or

contains profanity.

The profile text may be input into a machine learning model that has been trained to recognize the above, or other criteria, for filtering. Once the profile has passed through the filter without being discarded, the work experience sections may be extracted fir possible inclusion as examples. Each logic 1205, 1207, 1209, 1211 may be executed with similar filtering and analysis to provide custom key-value examples to be stored in Venice 1230.

In an embodiment, evaluation of the profile text may be ranked based on three general criteria:

social signals:

profile features, and

description/content features.

If the evaluation relied only on the description of the work experience, confidence may not be high that this is a valid or quality entry. Therefore, additional criteria is evaluated to provide quality examples.

In an embodiment, social signals may be used to determine whether the member is a respected or valued contributor to the career social network. Indicators that the member may be providing valuable work experience descriptions may be derived from one or more of:

number of inmail (e.g., email or messages) received from other members;

number of inmail (e.g., email or messages) received from recruiters;

number of connections to other members of the social network:

number of followers on the network:

number of endorsements, or recommendations:

number of profile views; or

skill reputation derived from a weighted combination of:
top skills listed for title.
score for skills (e.g., calculated from skill endorsements and other criteria):
number of connections; and
number of endorsements.

Features of the member's profile may be evaluated to ensure that the candidate can provide value added in an example. The member profile may be evaluated on factors such as:
current or past employment by a “quality” company, where a company may be scored or ranked based on one or more of:
   number of employees;
   revenue;
   public profile;
   great place to work awards;
   attracting talent with job postings:
      many applicants view job opening with the company; and/or
      many applicants apply for job openings with the company:
   average length of time an employee stays with the company;
   movement of people leaving other companies to join this one; and
   in the news:
received awards or public notoriety;
length of service;
years' of experience m the title or similar title (role);
quality or highly ranked schools in education section, and
recency score, e.g., how recent is the experience and duration of the experience.

Description and content features may be evaluated, for instance, for features based on the description text that aim to identify well written, relevant descriptions using natural language processing and trained models, and including one or more of:
spelling/grammar;
use of bullet points;
too many capital letters, or failure to capitalize when required;
repetitive text;
identifying when the style of the content reads more like a company or organization or
product description instead of a member profile work experience description;
recognizing poorly structured text, such as when text in consecutive bullet points contain very different syntactic structure;
number of key skills identified;
similarity with typical job postings for same title using data mining algorithms for measuring similarities; and
language model score, identifying a probability that the analyzed text is generated from the same distribution as the text the language model was trained on.

In an embodiment, a top N key-value examples are generated based on the quality criteria above to be stored in Venice 1230, in block 1213. The Venice database 1230 is configured to store all data into one key-value storage so it is easy to manage and scale. In an embodiment, for the use case of work experience examples and skill snippets having a job title (e.g., job role) and optional industry, the key may be defined as:

Title (Required);

Industry (Optional); and

Skill (Optional).

In this example, there are four cases of keys:

Title only;

Title and Industry;

Title and Skill, and

Title, Industry and Skill.

The data set of four cases together are combined in block 1213.

The pre-processing of work experience examples with top skills to generate smart snippets for display may be performed and stored as key-value entries in online and offline databases. The identification of the work experience examples for use with top skills occurs during backend pre-processing. However, in an embodiment, the actual smart snippet may be generated using the string matching just prior to being sent to the resume assistant, or performed during online processing and stored in online storage. This last minute generation allows for efficient use and scalability of the storage requirements of the backend Venice storage 1230. In an embodiment, a Hadoop to Venice (H2V) bridge 1210 may be used to port the work experience examples to the Venice database 1230, accessible via the stored index (e.g., profile id and position id). In an embodiment, Apache™ Kafka messaging 1220 may be used to assist in porting the examples to Venice 1230. Apache™ Kafka is an open-source stream processing publish-subscribe messaging platform which is known to be fast, scalable, durable, and fault-tolerant. The combined data is sent to Venice 1230 using Apache™ Kafka 1220 as a message queue and ZooKeeper as a controller.

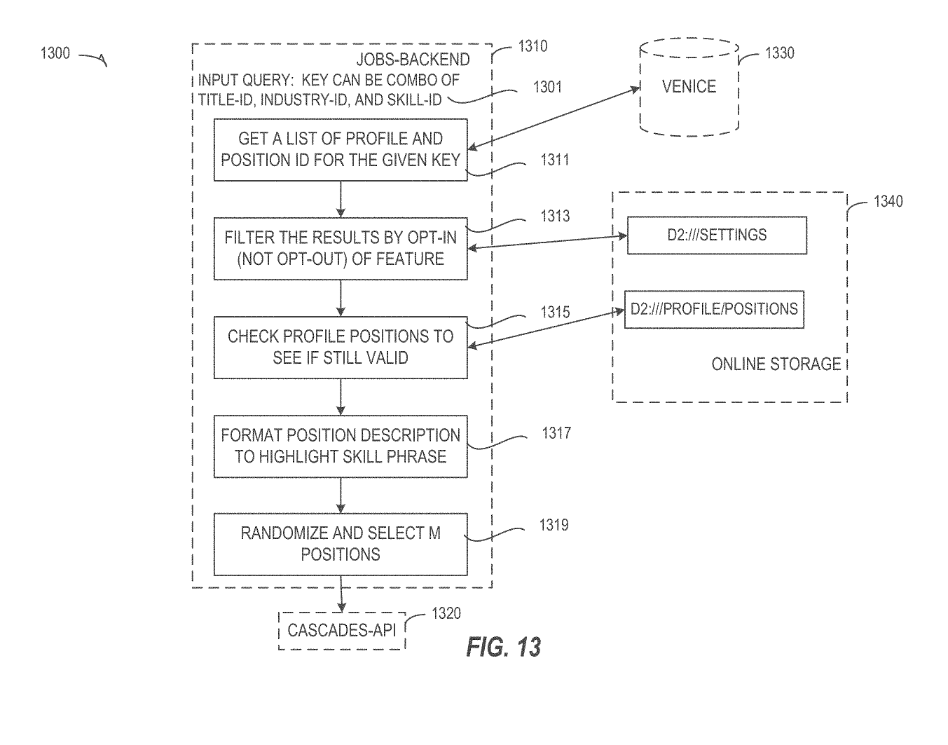

FIG. 13 illustrates a method 1300 of the backend for generating N positions for use as examples, according to an embodiment. An agent or process executing on a backend server 1310 receives a query 1301 requesting examples for document drafting assistant application. This request may be in the form a RESTful API call. In an example, the user wants examples for a specific job title, in a specific industry and having a specific skill. This combination of key-value examples has been stored in the Venice database 1330, as discussed above. The backend agent retrieves a list of profile and position identifiers (ID) for the given key at block 1311. In an embodiment, key-value combination examples may be recalculated on a daily basis. However, a user may change their profile settings regarding opt-in/opt-out or other privacy settings at any time. Therefore the backend process again filters the N examples by opt-in/opt-out at block 1313 to ensure that no unauthorized data is released to the user. Current settings and profile positions may be stored in an online storage area 1340 to be used for this real time authorization check. The profile positions in the proposed examples may be compared to real time/current profile position at block 1315 to ensure that the example is still valid. While the online storage may contain millions of profiles of information, this real time check may be performed quickly because only N profiles are compared in the real time check, and not the entire database of profiles. The position (e.g., work experience) may be formatted into a smart snippet or subset of the entire text to format for space on the user display, and/or to highlight a specified skill, phrase, or other criteria, in block 1317. Information that can identify the member is removed to anonymize the example to protect the privacy of the member. The N positions (minus the positions that have been filtered out) may be randomized, or sorted in a desired fashion, and then M positions may be returned to the Cascades-API 1320, in block 1319. In an embodiment N=100 and M=10 In practice, the number N of examples that should be retrieved from the database 1330 for a real time query should be large enough to accommodate last minute filtering and small enough not to stress memory storage and bandwidth requirements. This number may vary for different applications, and may depend on the number of key-value combinations necessary to accommodate user selectable criteria. The number M of examples returned to the user may be pre-selected, user selectable or be dependent on display resolution or local storage limitations. The M examples may appear in a scrollable window or pane or other display portion on the user display, and may not all be visible at the same time.

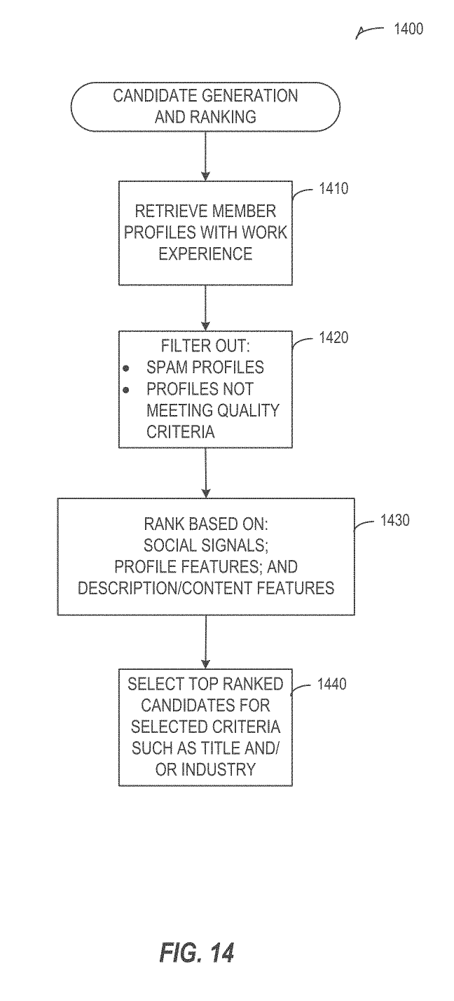

FIG. 14 illustrates a method 1400 for candidate generation and ranking in the backend to filter out low quality examples, according to an embodiment. In an embodiment, candidate generation may be performed in a backend processor to avoid lag time when a user requests document examples in an online application. As discussed above, an agent or process in the backend retrieves member profiles having work experience, in block 1410. The retrieved profiles are filtered for spam and other criteria, as discussed above, in block 1420. In an example, this filtering 1420 includes ensuring that the profile is in the opted in category (e.g. available for third party use), spam, length, profanity, and language used (e.g., English), etc. A next level of filtering, or ranking, may be performed to ensure that the work experience description extracted from the profile is high quality, in block 1430. As discussed above, one or more criteria associated with the member's profile may be evaluated, such as, social signals, profile features, and description/content features. Skill reputation, one of the social signals, may be derived from a measure of authority, popularity, expertise and influence. For instance, popularity and influence may be derived from social signals such as connections, message traffic and followers. Authority and expertise may be derived from job titles, endorsed skills and experience levels. In an example, a member may be deemed as having more authority when management skills or titles are present in the member profile.

In an embodiment, a model may be used to rank and filter quality profiles at 1430. In an example, the model may be initially tuned by using examples of work experiences labelled by human experts. Criteria may be weighted by importance, either manually, or based on trained models. Self-training techniques can be employed whereby an initial model is used to create new training data, which can selectively be used to train another model. If, upon an audit or inspection, high quality examples are being discarded or overlooked, or low quality examples are not being filtered out (e.g., as identified in the user feedback, as discussed above), weights may be manually altered, or additional data may be introduced to improve the model.

Once a score or weight (e.g., rank) has been assigned to a profile work experience description, the top scoring content may be selected for the selected key-value criteria, such as title-industry, title-skill, or title-industry-skill, etc, in block 1440. Ranked example candidates may be randomized and N examples may be returned to the Venice database for use in real time by the Cascades-API.

As discussed above, a machine learning approach may be used to identify quality work experience examples, but any one of a variety of approaches may be used to provide a quality score for a work experience. A skill reputation score may be used as one of the social signal features used for scoring and ranking examples. The skill reputation score may be a high-confidence, high-quality member-skill reputation matrix where each cell denotes the probability that the member is highly reputable at a given skill. The member-skill reputation matrix may be factorized using any one of a variety of matrix factorization techniques. A technique similar to latent semantic indexing may be used, which uses a specific kind of matrix factorization technique, singular value decomposition (SVD). Factorization may include solving a series of alternating least squares problems in an attempt to minimize the regularized sum of squared errors between the reconstruction and the original matrix (R) in this example.

It will be understood that the techniques described herein may be applied to applications other than for a resume assistant. Embodiments as described herein may be applied to varying document types that have defined quality criteria, such as “top” or “relevant” qualifiers for the content. Examples provided to the user for document types may be focused on criteria other than top skills. If a focus criteria can be associated with the examples, the smart snippets may be generated with respect to text surrounding the criteria of focus, as discussed more fully below. Any document type where a novice user may require help in document creation may use these techniques with some adaptation. For example, suppose a young company wants to answer a request for proposal (RFP) in a government contract, but is unsure of the best way to complete a past performance volume. The past performance volume may require skills, experience and other information to show that the company is capable of successfully completing the contract. If a database of winning contracts is available, the information in the database may provide example entries for the proposal document. In this case, top skills may be identified in the actual RFP, or by a management team within the company. In another example, a new recruiter in a hot industry wants to post a job opening and receive the most qualified candidates. Techniques as described herein may be used to provide example job postings for a specific role or title. While many of the examples herein have been in the job/skill or career area, techniques as described may be applied to document type assistance in other fields. As long as a database is available, or can be generated, with potential examples, and quality of an example can be quantified by measurable criteria the various factors may be used in a machine learning model to identify quality examples to be provided to users in real time to assist with document editing.

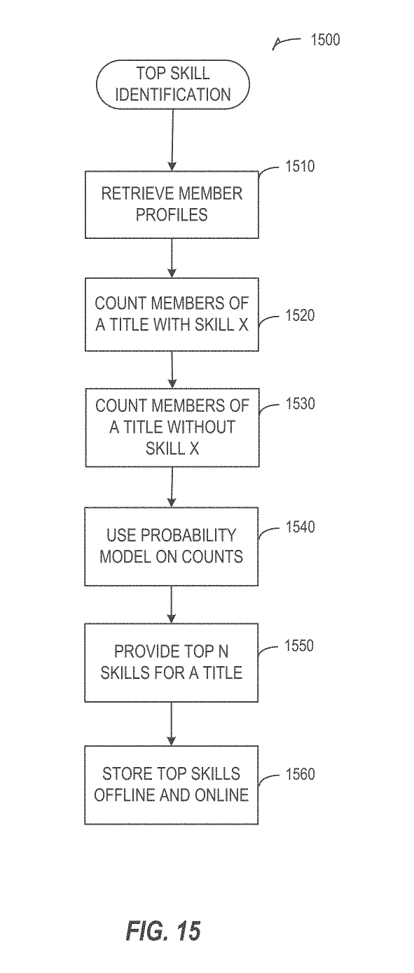

FIG. 15 is a flow diagram for an exemplary method 1500 for top skill identification, according to an embodiment. A backend process may retrieve member profiles from a member database, in block 1510. The number of members having a title associated with a skill X may be counted in block 1520. In an embodiment, a member profile maybe associated with a current title or role, and have a separate skill section identifying skills which may be endorsed by other members in the network. It may be assumed that the skills are identified with the current role, but further analysis may be conducted to determine whether the skill is associated with a previous role (e.g., previous job or career). For instance, a textual search of work experience may be conducted to identify the skill keyword in the experience descriptions. Varying level of analysis may be performed, as desired. A count of members having a title without the skill X listed is performed in block 1530.

A probability model may be performed on the model counts, in block 1540. In an embodiment, a g-value based on a G-test may be derived for a skill. G-tests are likelihood-ratio or maximum likelihood statistical significance tests that are increasingly being used in situations where chi-squared tests were previously recommended A G-statistic is a test for independence. It produces a g-value which may then be used to calculate a p-value which tells whether two variables are dependent or independent. In the case of identifying a top skill, the independency may be measured for between a user being in a Title@company bucket and the user having a skill. The g-value is used as the score. It should be noted that the score can be high even if there is negative affinity between the skill and the bucket. The higher the g-value, the higher relevancy of a title and a skill. Top skills stored for use with the document assistant may use this approach for member profiles in the member database. It will be understood that other methods of calculating top skills may be used, including manual or subjective generation of ranking supplied to the database.

In an example, a two contingency table for a G-test may look like Table 1.

TABLE 1
Outcomes Table

| | Users having | Users not having |
|---|---|---|
| | the skill | the skill |
| Users in Title1@Company1 Bucket | a (grid 0, 0) | b (grid 1, 0) |
| Users Not in Title1@Company1 | c (grid 0, 1) | d (grid 1, 1) |
| Bucket | | |

An expected table may look like Table 2.

TABLE 2
Expected Table

| | Users having the skill | Users not having the skill |
|---|---|---|
| Users in Title1@ | ((a + b) (a + c))/ | ((a + b)(b + d))/ |
| Company1 Bucket | (a + b + c + d) | (a + b + c + d) |
| Users Not in Title1@ | ((a + c)(c + d))/ | ((c + d) * (b + d))/ |
| Company1 Bucket | (a + b + c + d) | (a + b + c + d) |

The g-value may be calculated as 2*Oᵢ log (Oᵢ/Eᵢ), where Oᵢ is the observed count (e.g., outcome), and Eᵢ is the expected count, covering the four parts of the above table. In an example of a Software Engineer at Company Y, having Java programming as a skill, the table may be populated as Table 3.

TABLE 3
Results

| | Users having | Users not having |
|---|---|---|
| | the skill Java | the skill Java |
| Users in SWE @Company Y | 460 | 116 |
| Bucket | | |
| Users Not in SWE @Company Y | 2280255 | 71652340 |
| Bucket | | |

One may evaluate the g-value as it varies in value at grid (0, 0) from 0 to 576 (e.g., 576=460+116, or the total number of members either with or without the skill). The value in grid (0, 1) will vary from 576 to 0, in this example. A negative affinity may correspond to a region between where the g-value is >0 and corresponds to negative affinity. This may be handled by comparing the value of grid (0,0) in expected table to the value in grid (0,0) in the outcome table. If the expected table's grid (0,0) value is > the outcome grid that means it is negative affinity. Negative affinities may be scored as 0. The negative affinity check may be simplified as the calculation of (a*d)/(b*c)<1. Some popular skills may not be relevant to a specific title, but be relevant to all white collar jobs, for instance having competency with the Microsoft® Office suite of programs. The G-test intrinsically allows these generic skills to be filtered out as negative (or not positive) affinity with the title (role). Generally, a G-test represents the likelihood and is based on mutual information from the perspective of information theory. So, it the result is always greater than or equal to zero. In the present example, if a skill is totally irrelevant to a title, then the G value is 0. Otherwise, it is greater than 0.

In an example, there may be thousands of skills in the database. The number of skills applicable to a specific title may vary greatly. Some titles may have skills too numerous to list for a user. The top skills are seemingly more relevant for a user to include in the resume. In an embodiment. A quantity N top skills are selected for storing in the database to be used with smart snippets and work experiences. In an example, N=10. For some applications, it may be desirable to set N higher or lower, for instance. N=5 to 100. It will be understood that the number of top skills to be used may vary based on application. The N top skills are provided, in block 1550, and stored offline and online, in block 1560.

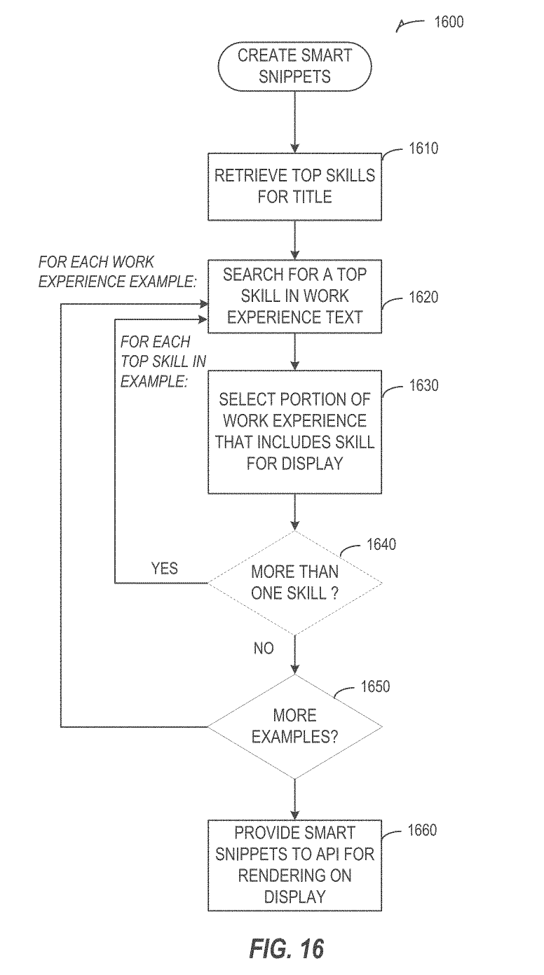

FIG. 16 is a flow diagram, of an exemplary method 1600 for creating smart snippets for an example according to an embodiment. In an embodiment, an offline pre-processor retrieves top skills for a title or role, in block 1610. The top skills may be stored in online and/or offline storage. Work experience examples for a title may be stored in an offline database storage accessible to the pre-processor. N work experience examples may be available for the title. In an embodiment, the work experience examples are retrieved for a role or role-industry combination, or other combination, if additional qualifiers are available. For each work experience example identified and retrieved for the selected criteria (e.g., role, role-industry, etc.), the text of the example is searched to determine whether it includes the selected top skill, in block 1620. In an embodiment, synonyms or similar wording may be searched in addition to an exact string search including the skill. When a match is determined by the search, a portion of the text in the work experience example may be selected as a smart snippet for display, in block 1630. The skill may be highlighted or bolded in the snippet, and the text may include some number of lines of sentences both before and/or after the text occurrence of the skill. The skill text may be rendered as a hyperlink to navigate the user to more information about the skill or bring up additional windows, panes or dialog boxes with additional information.

In an embodiment, more than one top skill may be selected by the user. In this case, a determination is made as to whether one or more additional skills should be searched in the work experience example, in block 1640. If there are additional skills, blocks 1620 and 1630 may be repeated for each selected skill. In another embodiment, the user may select one top skill, but the search 1620 may search for additional top skills in the list within the text of the work experience example. In this case, differing levels of indentation or highlight may be used to distinguish selected top skills from other top skills found, in the resulting smart snippet. In an example, if the top skills are within close proximity of each other in the text, a greater number of lines between the two occurrences may be included in the smart snippet, beyond the usual number of lines set to be shown before and after a skill.

The searching continues for the next example, when it is determined that additional examples are present for the criteria, m block 1650. The process 1620 to 1650 is repeated for examples and skills, as necessary. The snippets may be stored for later use, and/or be provided to the API requesting the examples with top skills, in block 1660. The smart snippets may be stored in an offline database so that they may be provided in real time, without re-generation being necessary, when an API request is received. The smart snippets stored in an online database are consistent to those the work experience examples in the offline database. As discussed above, the work experience example candidates are pre-processed and stored in the offline (backend) database. When a top skill is selected for focus, the smart snippet may be generated and stored m an online database for access by the API. In an embodiment a check is made to determine whether the example is still valid and authorized, as described above, before being sent to the user via the API. After rendering on the user display, the user may choose to select a different role or skill based on the information displayed. The work experience examples are generated in a backend process and stored in advance. Thus, the lag time to switch roles, industries and skills is short, thereby improving the user experience over alternatives such as having a human professional review the user's document and provide feedback. Further, since top skills may be updated less frequently than the work experience examples, the correlations are not likely to be out of date.

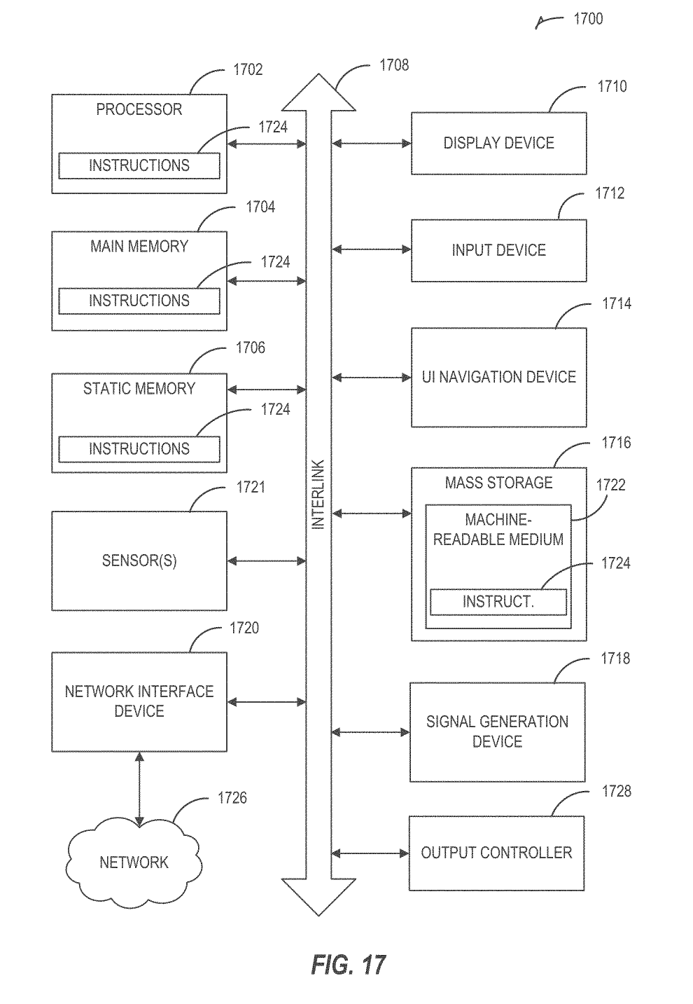

FIG. 17 illustrates a block diagram of an example machine 1700 upon which any one or more of the techniques (e.g., methodologies) discussed herein may perform. In alternative embodiments, the machine 1700 may operate as a standalone device or may be connected (e.g., networked) to other machines. In a networked deployment, the machine 1700 may operate m the capacity of a server machine, a client machine, or both in server-client network environments. In an example, the machine 1700 may act as a peer machine in peer-to-peer (P2P) (or other distributed) network environment. The machine 1700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specifications to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 1700 may include a hardware processor 1702 (e.g., a central processing unit (CPU), a graphics processing unit (GPU), a hardware processor core, or any combination thereof, a main memory 1704 and a static memory 1706, some or all of which may communicate with each other via an interlink (e.g., bus) 1708. The machine 1700 may further include a display unit 1710, an alphanumeric input device 1712 (e.g., a keyboard), and a user interface (UI) navigation device 1714 (e.g., a mouse). In an example, the display unit 1710, input device 1712 and UI navigation device 1714 may be a touch screen display. The machine 1700 may additionally include a storage device (e.g., drive unit) 1716, a signal generation device 1718 (e.g., a speaker), a network interface device 1720, and one or more sensors 1721, such as a global positioning system (GPS) sensor, compass, accelerometer, or other sensor. The machine 1700 may include an output controller 1728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1716 may include a machine readable medium 1722 on which is stored one or more sets of data structures or instructions 1724 (e.g., software) embodying or utilized by any one or more of the techniques or functions described herein. The instructions 1724 may also reside, completely or at least partially, within the main memory 1704, within static memory 1706, or within the hardware processor 1702 during execution thereof by the machine 1700. In an example, one or any combination of the hardware processor 1702, the main memory 1704, the static memory 1706, or the storage device 1716 may constitute machine readable media.

While the machine readable medium 1722 is illustrated as a single medium, the term “machine readable medium” may include a single medium or multiple media (e.g., a centralized or distributed database, and/or associated caches and servers) configured to store the one or more instructions 1724.

The term “machine readable medium” may include any medium that is capable of storing, encoding, or carrying instructions for execution by the machine 1700 and that cause the machine 1700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1724 may further be transmitted or received over a communications network 1726 using a transmission medium via the network interface device 1720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1720 may include one or more physical jacks (e.g., Ethernet, coaxial, or phone jacks) or one or more antennas to connect to the communications network 1726. In an example, the network interface device 1720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1700, and includes digital or analog communications signals or other intangible medium to facilitate communication of such software.

### ADDITIONAL NOTES AND EXAMPLES

Examples may include subject matter such as a method, means for performing acts of the method, at least one machine-readable medium including instructions that, when performed by a machine cause the machine to performs acts of the method, or of an apparatus or system for a Web-based automated document drafting assistant displaying examples focused on a specific criteria, according to embodiments and examples described herein.

Example 1 is a system for providing automated content examples, comprising: a processor communicatively coupled to a content database configured to store content correlated with a plurality of content criteria including contextual information, and communicatively coupled to a second database configured to store filtered content, the processor coupled to memory configured with instructions that when executed on the processor cause the system to: retrieve content from the content database; filter the content based on contextual criteria related to at least one quality measure; reduce the filtered content to a quantity N entries and store the reduced and filtered N entries in the second database, wherein the content is automatically re-filtered on a periodic basis to provide an updated N entries to overwrite the N entries in the second database, and responsive to a request for content examples by a document assistant application via an application program interface (API) call, wherein the request includes a content type, a criteria of focus, and optional criteria to identify a subset of content correlated with the optional criteria to: retrieve the N entries from the second database, select a quantity M<=N entries, determine whether an entry does not include text related to the criteria of focus, and when the entry does not include the text related to the criteria of focus, then omit the entry from being provided with the M entries, when the entry does include text related to the criteria of focus, apply the criteria of focus to each of the M entries and format the M entries for display, as smart snippets, wherein a viewable portion of the entry includes text related to the criteria of focus and one or more lines of text adjacent to the text related to the criteria of focus to provide contextual meaning to a viewer, and provide the M entries formatted for display in the document assistant application, to the API.

In Example 2, the subject matter of Example 1 optionally includes wherein the first database is configured to include content including member profiles of a job related social network, and wherein content includes work experience correlated with the member profiles and content criteria includes industry, job skill and job role, wherein the instructions are further configured to check if a member profile has been authorized for access, and if not, omit the member profile from the N entries, regardless of other quality criteria of the member profile.

In Example 3, the subject matter of Example 2 optionally includes wherein the at least one job skill is selected from a list of top skills derived from the member profiles in the content database, and wherein the list of top skills is automatically updated on a periodic basis.

In Example 4, the subject matter of any one or more of Examples 1-3 optionally include wherein the instructions are further configured to, responsive to a user selection of a criteria of focus related to a current display of content examples: automatically reformat entries in the current display of examples to include the text related to the criteria of focus and surrounding text, wherein the text related to the criteria of focus is visually highlighted; provide the reformatted entries to the document assistant via an API call; and omit entries that do not include the text related to the criteria of focus.

In Example 5, the subject matter of Example 4 optionally includes wherein the content database comprises member profile information including work experience information, wherein the content is a member profile, and the content criteria includes a job role, a job skill, and optional additional content criteria of industry related to a job role, wherein the criteria of focus comprises at least one job skill.

In Example 6, the subject matter of any one or more of Examples 1-5 optionally include wherein the second database is configured to store entries as key-value items, and where an upper bound on memory drives a maximum quantity of content criteria to be correlated with the content in formation of sets of key-value entries.

In Example 7, the subject matter of any one or more of Examples 2-6 optionally include additional instructions that when executed before sending the M entries to the API, cause the system to: access online storage configured with member profiles and associated settings; check for authorization for the M provided entries to ensure that each member profile associated with an entry has been authorized for access; check for changes in content from the provided entry from the second database and current member profile content, and anonymize the M entries, wherein if either or both of the check for authorization and check for changes fails, then omit the entry from the provided entries.

In Example 8, the subject matter of any one or more of Examples 2-7 optionally include wherein instructions filter the content based on contextual criteria related to the at least one quality measure includes instructions to generate a candidate entry based on a ranking of quality criteria derived from social signals, profile features and description features associated with a member profile, wherein the ranking includes using a machine learning model trained with quality criteria associated with a member profile including social signals, profile features and description features.

In Example 9, the subject matter of Example 8 optionally includes wherein the ranking of quality criteria includes instructions to assess the quality measure in context of the content criteria, and wherein the content criteria includes at least one of job role, industry and job skill.

Example 10 is a client device configured to operate a document assistant application, comprising: a processor communicatively coupled to both a display device and user input device, the processor coupled to a memory storing instructions that when executed by the processor cause the client device to: operate a document editor configured to render a document in a portion of the display, and configured with a document assistant add-in configured to provide content examples relevant to criteria associated with the document, wherein the document assistant add-in is further configured to: request content examples relevant to the criteria associated with the document from a backend server configured to store pre-processed content examples in key-value format relevant to the criteria, the request made via an application program interface (API); receive pre-processed and quality filtered examples relevant to the criteria from the backend server, wherein the pre-processed and quality filtered examples are checked for relevancy and authorization in real time, responsive to the request, and only relevant and authorized examples are sent from the backend server render at least one of the received pre-processed and quality filtered examples in an area on the display device in proximity of the rendered document, and responsive to user input via the user input device, modify the criteria associated with the document as sent to the backend server, to either focus or broaden the content examples, and receive updated content examples for rendering on the display device, wherein to focus the content examples includes sending a criteria of focus to the backend processor, the criteria of focus being related to the criteria of the content examples, and wherein responsive to receiving the updated content examples formatted to highlight the criteria of focus, automatically rendering the updated content examples on the display.

In Example 11, the subject matter of Example 10 optionally includes wherein the document has a content type and the criteria associated with the document is dependent on the document type and user input.

In Example 12, the subject matter of Example 11 optionally includes wherein the document type is a job related document, and the content database is configured to include content including member profiles of a job related social network, and wherein content includes work experience correlated with the member profiles and content criteria is user selectable via the user input device and includes industry, job skill and job role.

In Example 13, the subject matter of any one or more of Examples 11-12 optionally include wherein the content examples are selected from member profiles of a job-based social network database, and filtered by the backend server for quality based on the criteria and member profile quality measures derived from social signals, profile features, and description features associated with a member profile, wherein member profiles are input to a machine learning model and ranked for quality, and only member profiles meeting a quality threshold are sent as content examples.

In Example 14, the subject matter of Example 13 optionally includes wherein the at least one job skill is selected from a list of top skills derived from the member profiles in the content database, and wherein the list of top skills is updated on a periodic basis, wherein the list of top skills is automatically presented in a user selectable display adjacent to the received pre-processed and quality filtered examples, and wherein responsive to user selection of at least one of the top skills as a criteria of focus, automatically rendering the updated content examples on the display as focused, with respect to the at least one of the top skills selected.

Example 15 is a computer implemented method for generating content examples, comprising: retrieving a plurality of content items from a first database, wherein each content item has a content type and includes information relevant to one or more user selectable criteria; filtering the plurality of content items based on quality criteria to remove content items of an incorrect content type or quality level; ranking each of the plurality of content items based on at least one quality measure corresponding to the user selectable criteria or objective criteria related to the content type; selecting a quantity N of higher ranking candidates related to the user selectable criteria; storing the N selected higher ranking candidates m a memory store accessible via an application program interface (API) call from a document assistant Web-application; generating a focused display for at least one of the N higher ranking candidates, wherein the focused display includes a correlation to content criteria associated with the at least one of the N higher ranking candidates and at least one criteria of focus, wherein text m the focused display includes text related to the criteria of focus and one or more lines of adjacent text to provide contextual meaning to a viewer, wherein the focused display is stored in the memory store accessible via an application program interface (API) call from the document assistant Web-application.

In Example 16, the subject matter of Example 15 optionally includes wherein the first database comprises member profile information including work experience information, wherein the content type is a member profile, and user selectable criteria includes at least one of a job role, industry related to the job role, or job skill, and the criteria of focus is a job skill selected from a list of top job skills derived from the member profile information, and wherein the list of top job skills is automatically updated on a periodic basis.

In Example 17, the subject matter of Example 16 optionally includes determining the at least one quality measure through analysis of at least one of social signals corresponding the member profile, features of the member profile, or content of the member profile.

In Example 18, the subject matter of Example 17 optionally includes wherein the determining the at least one quality measure further comprises: determining the at least one quality measure through analysis of the at least one of the social signals corresponding the member profile, features of the member profile, or content of the member profile with respect to selected user selectable criteria.

In Example 19, the subject matter of Example 18 optionally includes wherein the user selected criteria is a job role and the analysis of the at least one of social signals corresponding the member profile, features of the member profile, or content of the member profile is performed in the context of the job role selected.

In Example 20, the subject matter of any one or more of Examples 18-19 optionally include wherein the user selected criteria is a job role and at least one additional criteria, and the analysis of the at least one of social signals corresponding the member profile, features of the member profile, or content of the member profile is performed in the context of the job role selected, and the at least one additional criteria.

In Example 21, the subject matter of any one or more of Examples 15-20 optionally include selecting a quantity M of the N selected higher ranking candidates, wherein M is less than or equal to N; formatting displayable content corresponding to the M selected higher ranking candidates in a focused display highlighting the criteria of focus, and storing the displayable content as a smart snippet in a memory store accessible via the application program interface (API) call from the document assistant Web-application.

In Example 22, the subject matter of any one or more of Examples 15-21 optionally include automatically retrieving the plurality of content items from the first database, on a periodic basis and repeating the filtering, ranking and selecting activities, and storing an updated N candidates in the memory store.

In Example 23, the subject matter of any one or more of Examples 15-22 optionally include wherein the content items in the first database are associated with member profiles including work experience, further comprising: determining whether a member profile is authorized for sharing with third parties, and if the member profile is not authorized, the omitting the content items corresponding to the member profile from the N higher ranking candidates.

Example 24 is a system configured to perform operations of any one or more of Examples 1-23.

Example 25 is a method for performing operations of any one or more of Examples 1-23.

Example 26 is a at least one machine readable medium including instructions that, when executed by a machine cause the machine to perform the operations of any one or more of Examples 1-23.

Example 27 is a system comprising means for performing the operations of any one or more of Examples 1-23

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced m distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software, the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A.” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill m the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A system for providing automated content examples, comprising:
a processor communicatively coupled to a content database configured to store content correlated with a plurality of content criteria including contextual information, and communicatively coupled to a second database configured to store filtered content, the processor coupled to memory configured with instructions that when executed on the processor cause the system to:
retrieve content from the content database;
filter the content based on contextual criteria related to at least one quality measure;
reduce the filtered content to a quantity N entries and store the reduced and filtered N entries in the second database, wherein the content is automatically re-filtered on a periodic basis to provide an updated N entries to overwrite the N entries in the second database; and
responsive to a request for content examples by a document assistant application via an application program interface (API) call, wherein the request includes a content type, a criteria of focus, and optional criteria to identify a subset of content correlated with the optional criteria to:
retrieve the N entries from the second database,
select a quantity M<=N entries,
determine whether an entry does not include text related to the criteria of focus, and when the entry does not include the text related to the criteria of focus, then omit the entry from being provided with the M entries,
when the entry does include text related to the criteria of focus, apply the criteria of focus to each of the M entries and format the M entries for display, as smart snippets, wherein a viewable portion of the entry includes text related to the criteria of focus and one or more lines of text adjacent to the text related to the criteria of focus to provide contextual meaning to a viewer, and
provide the M entries formatted for display in the document assistant application, to the API.

2. The system as recited in claim 1, wherein the first database is configured to include content including member profiles of a job related social network, and wherein content includes work experience correlated with the member profiles and content criteria includes industry, job skill and job role, wherein the instructions are further configured to check if a member profile has been authorized for access, and if not, omit the member profile from the N entries, regardless of other quality criteria of the member profile.

3. The system as recited in claim 2, wherein the at least one job skill is selected from a list of top skills derived from the member profiles in the content database, and wherein the list of top skills is automatically updated on a periodic basis.

4. The system as recited in claim 1, wherein the instructions are further configured to, responsive to a user selection of a criteria of focus related to a current display of content examples:
automatically reformat entries in the current display of examples to include the text related to the criteria of focus and surrounding text, wherein the text related to the criteria of focus is visually highlighted;
provide the reformatted entries to the document assistant via an API call; and
omit entries that do not include the text related to the criteria of focus.

5. The system as recited in claim 4, wherein the content database comprises member profile information including work experience information, wherein the content is a member profile, and the content criteria includes a job role, a job skill, and optional additional content criteria of industry related to a job role, wherein the criteria of focus comprises at least one job skill.

6. The system as recited in claim 1, wherein the second database is configured to store entries as key-value items, and where an upper bound on memory drives a maximum quantity of content criteria to be correlated with the content in formation of sets of key-value entries.

7. The system as recited in claim 2, further comprising additional instructions that when executed before sending the M entries to the API, cause the system to:
access online storage configured with member profiles and associated settings;
check for authorization for the M provided entries to ensure that each member profile associated with an entry has been authorized for access;
check for changes in content from the provided entry from the second database and current member profile content; and
anonymize the M entries, wherein if either or both of the check for authorization and check for changes fails, then omit the entry from the provided entries.

8. The system as recited in claim 2, wherein instructions filter the content based on contextual criteria related to the at least one quality measure includes instructions to generate a candidate entry based on a ranking of quality criteria derived from social signals, profile features and description features associated with a member profile, wherein the ranking includes using a machine learning model trained with quality criteria associated with a member profile including social signals, profile features and description features.

9. The system as recited in claim 8, wherein the ranking of quality criteria includes instructions to assess the quality measure in context of the content criteria, and wherein the content criteria includes at least one of job role, industry and job skill.

10. A client device configured to operate a document assistant application, comprising:
a processor communicatively coupled to both a display device and user input device, the processor coupled to a memory storing instructions that when executed by the processor cause the client device to:
operate a document editor configured to render a document m a portion of the display, and configured with a document assistant add-in configured to provide content examples relevant to criteria associated with the document, wherein the document assistant add-in is further configured to:
request content examples relevant to the criteria associated with the document from a backend server configured to store pre-processed content examples in key-value format relevant to the criteria, the request made via an application program interface (API);
receive pre-processed and quality filtered examples relevant to the criteria from the backend server, wherein the pre-processed and quality filtered examples are checked for relevancy and authorization in real time, responsive to the request, and only relevant and authorized examples are sent from the backend server;
render at least one of the received pre-processed and quality filtered examples in an area on the display device in proximity of the rendered document; and
responsive to user input via the user input device, modify the criteria associated with the document as sent to the backend server, to either focus or broaden the content examples, and receive updated content examples for rendering on the display device, wherein to focus the content examples includes sending a criteria of focus to the backend processor, the criteria of focus being related to the criteria of the content examples, and wherein responsive to receiving the updated content examples formatted to highlight the criteria of focus, automatically rendering the updated content examples on the display.

11. The client device as recited in claim 10, wherein the document has a content type and the criteria associated with the document is dependent on the document type and user input.

12. The client device as recited in claim 11, wherein the document type is a job related document, and the content database is configured to include content including member profiles of a job related social network, and wherein content includes work experience correlated with the member profiles and content criteria is user selectable via the user input device and includes industry, job skill and job role.

13. The client device as recited in claim 11, wherein the content examples are selected from member profiles of a job-based social network database, and filtered by the backend server for quality based on the criteria and member profile quality measures derived from social signals, profile features, and description features associated with a member profile, wherein member profiles are input to a machine learning model and ranked for quality, and only member profiles meeting a quality threshold are sent as content examples.

14. The system as recited in claim 13, wherein the at least one job skill is selected from a list of top skills derived from the member profiles in the content database, and wherein the list of top skills is updated on a periodic basis, wherein the list of top skills is automatically presented in a user selectable display adjacent to the received pre-processed and quality filtered examples, and wherein responsive to user selection of at least one of the top skills as a criteria of focus, automatically rendering the updated content examples on the display as focused, with respect to the at least one of the top skills selected.

15. A computer implemented method for generating content examples, comprising:
retrieving a plurality of content items from a first database, wherein each content item has a content type and includes information relevant to one or more user selectable criteria;
filtering the plurality of content items based on quality criteria to remove content items of an incorrect content type or quality level;
ranking each of the plurality of content items based on at least one quality measure corresponding to the user selectable criteria or objective criteria related to the content type;
selecting a quantity N of higher ranking candidates related to the user selectable criteria;
storing the N selected higher ranking candidates in a memory store accessible via an application program interface (API) call from a document assistant Web-application;
generating a focused display for at least one of the N higher ranking candidates, wherein the focused display includes a correlation to content criteria associated with the at least one of the N higher ranking candidates and at least one criteria of focus, wherein text in the focused display includes text related to the criteria of focus and one or more lines of adjacent text to provide contextual meaning to a viewer, wherein the focused display is stored in the memory store accessible via an application program interface (API) call from the document assistant Web-application.

16. The computer implemented method as recited in claim 15, wherein the first database comprises member profile information including work experience information, wherein the content type is a member profile, and user selectable criteria includes at least one of a job role, industry related to the job role, or job skill, and the criteria of focus is a job skill selected from a list of top job skills derived from the member profile information, and wherein the list of top job skills is automatically updated on a periodic basis.

17. The computer implemented method as recited in claim 16, further comprising:
determining the at least one quality measure through analysis of at least one of social signals corresponding the member profile, features of the member profile, or content of the member profile.

18. The computer implemented method as recited in claim 17, wherein the determining the at least one quality measure further comprises:
determining the at least one quality measure through analysis of the at least one of the social signals corresponding the member profile, features of the member profile, or content of the member profile with respect to selected user selectable criteria.

19. The computer implemented method as recited in claim 18, wherein the user selected criteria is a job role and the analysis of the at least one of social signals corresponding the member profile, features of the member profile, or content of the member profile is performed in the context of the job role selected.

20. The computer implemented method as recited in claim 18, wherein the user selected criteria is a job role and at least one additional criteria, and the analysis of the at least one of social signals corresponding the member profile, features of the member profile, or content of the member profile is performed in the context of the job role selected, and the at least one additional criteria.

21. The computer implemented method as recited in claim 15, further comprising:
selecting a quantity M of the N selected higher ranking candidates, wherein M is less than or equal to N;
formatting displayable content corresponding to the M selected higher ranking candidates in a focused display highlighting the criteria of focus; and
storing the displayable content as a smart snippet in a memory store accessible via the application program interface (API) call from the document assistant Web-application.

22. The computer implemented method as recited in claim 15, further comprising:
automatically retrieving the plurality of content items from the first database, on a periodic basis and repeating the filtering, ranking and selecting activities, and storing an updated N candidates in the memory store.

23. The computer implemented method as recited in claim 15, wherein the content items in the first database are associated with member profiles including work experience, further comprising:
determining whether a member profile is authorized for sharing with third parties, and if the member profile is not authorized, the omitting the content items corresponding to the member profile from the N higher ranking candidates.
